(19) United States
(12) Patent Application Publication
(10) Pub. No.: US 2017/0074401 A1
(43) Pub. Date: Mar. 16, 2017

(54) PRESS-IN-PLACE GASKET

(71) Applicant: Parker-Hannifin Corporation, Cleveland, OH (US)

(72) Inventors: Robert Kent SAXTON, Forest, VA (US); William V. BLEVINS, JR., Middlebury, IN (US)

(21) Appl. No.: 15/264,892

(22) Filed: Sep. 14, 2016

Related U.S. Application Data
(60) Provisional application No. 62/219,361, filed on Sep. 16, 2015.

(51) Int. Cl. F16J 15/02

(52) U.S. Cl. CPC F16J 15/022

(57) ABSTRACT

A gasket includes a main body being a first compressible elastomeric material and having a generally planar and annular shape; and at least one fluid passage sealing element being of a second compressible elastomeric material different from the first compressible elastomeric material, the at least one fluid passage sealing element joined to the main body, wherein a curing system of the first elastomeric material is substantially the same as a curing system of the second elastomeric material

### TECHNICAL FIELD

The present invention relates broadly to a sealing construction for providing a fluid seal intermediate a pair of opposed, mating parts or structures, and more particularly to an elastomeric gasket construction for use in vehicles and engines of all types.

### BACKGROUND

Gaskets of the type herein involved are employed in a variety of sealing applications, such as in commercial, industrial, or military equipment, vehicles, or aircraft for compression between the opposing or faying surfaces of a pair of mating parts or structures to provide a fluid-tight interface sealing thereof.

In service, the gasket is clamped between the mating surfaces to effect the compression and deformation of the seal member and to develop a fluid-tight interface with each of those surfaces. Most often, the compressive force is provided using a circumferentially spaced-apart arrangement of bolts or other fastening members, each of which is received through an indexed pair of bores formed within the surfaces. Depending on the geometry of the gasket, the fastening members also may be indexed through corresponding apertures formed within the seal or retainer member of the gasket.

Press-in-place (PIP) gaskets are typically installed into a groove or cavity which is cast, molded or machined into one or both components to be joined. PIP gaskets are generally relatively thin bands of rubber or elastomeric material that are molded to have a shape corresponding to that of the groove or cavity formed in one or both of the components to be sealed and typically do not require adhesives to stay in place.

### SUMMARY

In one aspect of the invention there is provided a gasket that includes a main body being a first compressible elastomeric material and having a generally planar and annular shape; and at least one fluid passage sealing element being of a second compressible elastomeric material different from the first compressible elastomeric material, the at least one fluid passage sealing element joined to the main body; wherein a curing system of the first elastomeric material is substantially the same as a curing system of the second elastomeric material.

The curing system common to the first and second elastomeric materials may be selected from among peroxide, sulfur, metallic oxide, acetoxysilane and urethane crosslinkers.

In one embodiment, the first elastomeric material and the second elastomeric material cure at a compatible cure rate.

The first elastomer and the second elastomer may be independently selected from among natural polyisoprene (NR), synthetic polyisoprene (IR), polybutadiene (BR), chloroprene rubber (CR), butyl rubber, styrene-butadiene rubber (SBR), nitrile rubber (NBR), hydrogenated butadiene rubber (HNBR), ethylene-propylene rubber (EPM), ethylene-propylene-diene rubber (EPDM), ethylene acrylic rubber (AEM), polyacrylic rubber (ACM, ABR), silicone rubber, fluorosilicones, fluoroelastomers (FKM), perfluoroelastomers (FFKM), polyether block amides (PEBA), chlorosulfonated polyethylene, ethylene-vinyl acetate (EVA), and blends of two or more thereof.

In one embodiment, the first elastomer includes an ethylene acrylic elastomer and the second elastomer includes a fluoroelastomer.

In one embodiment, the curing system common to the first and second elastomeric materials includes peroxide.

The main body and the at least one fluid passage sealing element of the gasket may be co-molded by an injection molding process. Alternatively, the main body and the at least one fluid passage sealing element of the gasket are co-molded by a compression molding process. In another embodiment, the main body and the at least one fluid passage sealing element of the gasket are co-molded by a transfer molding process.

### BRIEF DESCRIPTION OF THE DRAWINGS

FIG. 1 is a plan view of an exemplary embodiment of a press-in-place gasket according to the present invention.

FIG. 2 is an enlarged view of a section of the gasket of FIG. 1 at a fluid passage.

FIG. 3 is a cross-sectional view taken along line 3-3 in FIG. 2 through the first and second elastomeric materials.

### DETAILED DESCRIPTION

The principles, embodiments and operation of the present invention are shown in the accompanying drawings and described in detail herein. These drawings and this description are not to be construed as being limited to the particular illustrative forms of the invention disclosed. It will become apparent to those skilled in the art that various modifications of the embodiments herein can be made without departing from the spirit or scope of the invention.

The precepts of the flexible gasket construction of the present invention are described for illustrative purposes in connection with the configuration thereof for use as a cam cover seal for an automotive engine. With the interface surface of these structures registered in confronting opposition, the gasket of the invention may be compressed therebetween by means of a plurality of bolts or other fastening members received through registered pairs of openings spaced circumferentially about the interface surfaces.

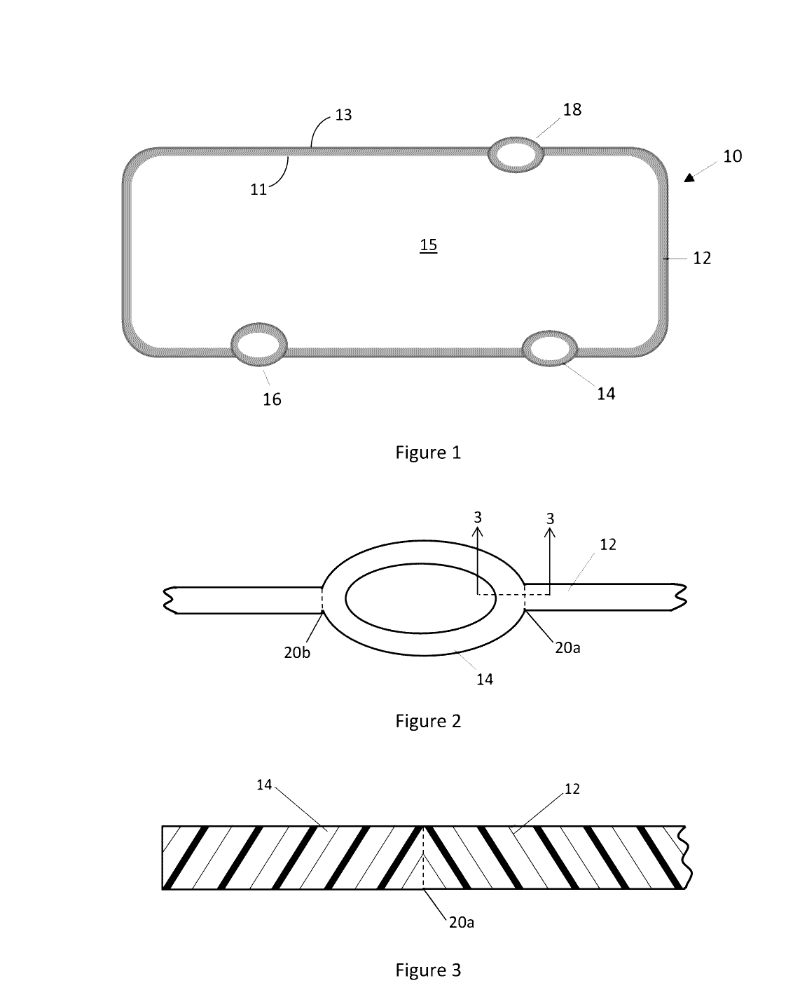

Referring to FIG. 1, an embodiment of a flexible, push-in-place gasket 10 according to the present invention is illustrated. The gasket 10 is configured for interposition between a mating pair of curved, mutually-opposed interface surfaces. The gasket 10 includes a generally planar and annular shape and one or more fluid passage sealing elements 14, 16, 18, within the main body 12 of the gasket 10 for effecting a fluid-tight sealing around one or more fluid passages within the interface surfaces (not shown in FIG. 1).

The main body 12 and each of the sealing elements 14, 16, 18 is formed of a rubber or other elastomeric material which may be selected specifically for compatibility with the fluid being handled. Suitable materials include natural rubbers, as well as thermoplastic, i.e., melt-processible, or thermosetting, i.e., vulcanizable, synthetic rubbers. Examples of rubbers and elastomeric materials include natural polyisoprene (NR), synthetic polyisoprene (IR), polybutadiene (BR), chloroprene rubber (CR), butyl rubber, styrene-butadiene rubber (SBR), nitrile rubber (NBR), hydrogenated nitrile butadiene rubber (HNBR), ethylene-propylene rubber (EPM), ethylene-propylene-diene rubber (EPDM), ethylene acrylic rubber (AEM), polyacrylic rubber (ACM, ABR), silicone rubber, fluorosilicones, fluoroelastomers (FKM), perfluoroelastomers (FFKM), polyether block amides (PEBA), chlorosulfonated polyethylene, ethylene-vinyl acetate (EVA), and blends of two or more thereof.

The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

The gasket 10 is formed having an inner perimeter 11 and an outer perimeter or margin 13, which together define an opening 15 of a closed geometric shape. Although the shape of the main body 12 of gasket 10 is shown for purposes of illustration to be generally rectangular, such shape alternatively may be square or otherwise regular polygonal, irregular, circular, elliptical, or otherwise arcuate depending on the intended application. Similarly, although the shape of the fluid passage sealing elements 14, 16, 18 is shown for purposes of illustration to be generally elliptical, such shape alternatively may independently be rectangular, square or otherwise regular polygonal, irregular, or circular.

The main body 12 of gasket 10 is molded of a first elastomeric material and at least one of the fluid passage sealing elements 14, 16 and 18 is molded of a second elastomeric material that is different from the first elastomeric material.

Referring to FIG. 2, the body of fluid passage sealing element 14 is constructed of an elastomeric material having enhanced chemical resistance, such as, for example, a fluoroelastomer (FKM). The main body 12 is constructed of an elastomeric material that differs from the elastomeric material of the body of fluid passage sealing element 14, but that is compatible with and that can be cured by the same curing mechanism as the elastomeric material of the fluid passage sealing element 14. For example, the main body 12 may be constructed of an ethylene acrylic elastomer (AEM), and both the FKM of the fluid passage sealing element 14 and the AEM of the main body 12 are cured by a peroxide curing system. The body of the fluid passage sealing element 14 and the main body 12 can be co-molded by compression molding, injection molding or transfer molding, and then cured to form bonds between the first and second elastomeric materials along bondlines 20a and 20b.

Referring to FIG. 3, the first elastomeric material of the main body 12 is crosslinked to the second elastomeric material of the fluid passage sealing element 14 along bondline 20a. The bondline between the first elastomeric material and the second elastomeric material may be a sharp, i.e., very narrow region, or may be a wider region where there is comingling of the first and second elastomeric materials. No adhesive or bonding agent is needed to bond the first elastomeric material of the main body 12 to the second elastomeric material of the fluid passage sealing element 14. The bond between the first elastomeric material and the second elastomeric material is sufficiently strong to prevent failure of the gasket at the bondline.

In one embodiment, the majority of the gasket is molded of a less expensive elastomeric material, and one or more specific areas of the gasket, such as one or more fluid passage sealing elements, are molded of a more expensive material that provides enhanced properties to those specific areas of the gasket.

In one embodiment, the main body 12 of the gasket is formed of a first elastomeric material, a first fluid passage sealing element 14 is formed of a second elastomeric material that is compatible with and curable by the same mechanism as the first elastomeric material, a second fluid passage sealing element 16 is formed of a third elastomeric material that is compatible with and curable by the same mechanism as the first elastomeric material. In this embodiment, the second elastomeric material is chosen to be resistant to the fluid passing through fluid passage sealing element 14. The third elastomeric material is chosen to be resistant to the fluid passing through fluid passage sealing element 16. The fluids passing through fluid passage sealing elements 14 and 16 may be engine oil, coolant, transmission oil, air/fuel mixtures, brake fluid, axle/gear lubricants, blow-by-gases, highly acidic mixtures of oil, fuel and acid vapors, and the like.

The press-in-place gasket described herein is manufactured by molding techniques that do not require application of the elastomeric materials to a carrier layer and/or adhesive bonding of the elastomeric materials to a carrier layer.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A gasket comprising:
a main body being a first compressible elastomeric material and having a generally planar and annular shape; and
at least one fluid passage sealing element being of a second compressible elastomeric material different from the first compressible elastomeric material, the at least one fluid passage sealing element joined to the main body;
wherein a curing system of the first elastomeric material is substantially the same as a curing system of the second elastomeric material.

2. The gasket of claim 1, wherein the curing system common to the first and second elastomeric materials is selected from among peroxide, sulfur, metallic oxide, acetoxysilane and urethane crosslinkers.

3. The gasket of claim 1, wherein the first elastomeric material and the second elastomeric material cure at a compatible cure rate.

4. The gasket of claim 1, wherein the first elastomer is selected from among natural polyisoprene (NR), synthetic polyisoprene (IR), polybutadiene (BR), chloroprene rubber (CR), butyl rubber, styrene-butadiene rubber (SBR), nitrile rubber (NBR), hydrogenated nitrile butadiene rubber (HNBR), ethylene-propylene rubber (EPM), ethylene-propylene-diene rubber (EPDM), ethylene acrylic rubber (AEM), polyacrylic rubber (ACM, ABR), silicone rubber, fluorosilicones, fluoroelastomers (FKM), perfluoroelastomers (FFKM), polyether block amides (PEBA), chlorosulfonated polyethylene, ethylene-vinyl acetate (EVA), and blends of two or more thereof.

5. The gasket of claim 1, wherein the second elastomer is selected from among natural polyisoprene (NR), synthetic polyisoprene (IR), polybutadiene (BR), chloroprene rubber (CR), butyl rubber, styrene-butadiene rubber (SBR), nitrile rubber (NBR), hydrogenated nitrile butadiene rubber (HNBR), ethylene-propylene rubber (EPM), ethylene-propylene-diene rubber (EPDM), ethylene acrylic rubber (AEM), polyacrylic rubber (ACM, ABR), silicone rubber, fluorosilicones, fluoroelastomers (FKM), perfluoroelastomers (FFKM), polyether block amides (PEBA), chlorosulfonated polyethylene, ethylene-vinyl acetate (EVA), and blends of two or more thereof.

6. The gasket of claim 1, wherein the first elastomer comprises an ethylene acrylic elastomer and the second elastomer comprises a fluoroelastomer.

7. The gasket of claim 1, wherein the curing system common to the first and second elastomeric materials comprises peroxide.

8. The gasket of claim 1, wherein the main body and the at least one fluid passage sealing element are co-molded by an injection molding process.

9. The gasket of claim 1, wherein the main body and the at least one fluid passage sealing element are co-molded by a compression molding process.

10. The gasket of claim 1, wherein the main body and the at least one fluid passage sealing element are co-molded by a transfer molding process.
